(19) United States
(12) Patent Application Publication
(10) Pub. No.: US 2014/0175061 A1
(43) Pub. Date: Jun. 26, 2014

(54) ELECTRICAL SWITCHING DEVICE WITH A TRIPLE MOTION CONTACT ARRANGEMENT

(71) Applicant: ABB TECHNOLOGY AG, Zurich (CH)

(72) Inventors: Helmut HEIERMEIER, Wutoschingen (DE); Jadran KOSTOVIC, Wettingen (CH); Jakub KORBEL, Baden (CH); Reto KARRER, Stafa (CH); Sami KOTILAINEN, Niederrohrdof (CH); Timothy SUTHERLAND, Zweidlen (CH); Brant SUHRIE, Erie, PA (US)

(73) Assignee: ABB Technology AG, Zurich (CH)

(21) Appl. No.: 13/721,817

(22) Filed: Dec. 20, 2012

(51) Int. Cl. H01H 3/00

(52) U.S. Cl. CPC H01H 3/00
USPC 218/154

(57) ABSTRACT

A contact arrangement has a longitudinal axis (z) with a first contact group having a first contact and a second contact, and a second contact group having a third contact and a fourth contact. The first contact interacts electrically and mechanically with the third contact, and/or the second contact interacts electrically and mechanically with the fourth contact. At least one mechanical coupling is provided for transmitting an actuation force to the second contact group and thereby moving the second contact group. The third and the fourth contact can move in such a way that their speeds differ along at least a portion of a travel path of the third contact or of the fourth contact.

### TECHNICAL FIELD

The invention relates to the field of medium and high voltage switching technologies and concerns a contact arrangement and an electrical switching device with such a contact arrangement according to the independent claims, particularly for a use as an earthing device, a fast-acting earthing device, a circuit breaker, a generator circuit breaker, a switch disconnector, a combined disconnector and earthing switch, or a load break switch in power transmission and distribution systems.

### BACKGROUND

Electrical switching devices are well known in the field of medium and high voltage switching applications. They are e.g. used for interrupting a current when an electrical fault occurs. As an example for an electrical switching device, circuit breakers have the task of opening contacts and keeping them far apart from one another in order to avoid a current flow, even in case of high electrical potential originating from the electrical fault itself. For the purposes of this disclosure the term medium voltage refers to voltages from 1 kV to 72.5 kV and the term high voltage refers to voltages higher than 72.5 kV. The electrical switching devices, like said circuit breakers, may have to be able to carry high nominal currents of 5000 A to 6300 A and to switch very high short circuit currents of 63 kA to 80 kA at very high voltages of 550 kV to 1200 kV.

Because of the high nominal current, the electrical switching devices of today require many so-called nominal contact fingers for the nominal current. When disconnecting (opening) a nominal or short circuit current within the electrical switching devices, the current commutates from nominal contacts of the electrical switching device to its arcing contacts. When connecting (closing) the nominal contacts of the electric switching device, also the arcing contacts are connected. They normally comprise as a first arcing contact arcing contact fingers arranged around the longitudinal axis of the electrical switching device in a so-called arcing finger cage and, as a second arcing contact, a rod which is driven into the finger cage.

During the closing and opening process of the electrical switching device an electric arc forms between the first and the second arcing contact, which damages the contacts over time. In order to minimize this damage the electrical switching devices contain a fluid used to quench the electric arc as fast as possible. Another measure is to limit the time period for the entire closing and opening process of the nominal and arcing contacts, particularly the time period or time interval between contacting the nominal contacts and contacting the arcing contacts or between separating the nominal contacts and separating the arcing contacts. This time constraint results in the necessity of accelerating and decelerating the nominal contact and the arcing contact on one side of the electrical switching device according to the given time period. The contacts have to have a certain cross-section in order to be able to carry the required current. Very high voltage circuit breakers require a longer distance between contacts in an opened state in order to avoid electrical breakdown. Hence, considerable forces are necessary to accelerate and/or decelerate the contacts and the additional moving parts of the switching device. These forces may lead to increased mechanical stress on the moving parts of the contact arrangement and even to mechanical failures, thus reducing the lifetime of such an electrical switching device. Furthermore, particles are generated during the switching process of the circuit breaker, which can result in dielectric failures.

### DESCRIPTION OF THE INVENTION

Thus, it is an objective of the present invention to improve a contact arrangement with respect to the above mentioned disadvantages. This task is solved by the contact arrangement and circuit breaker of the independent claims. Embodiments are given by dependent claims and their combinations.

In a first aspect of the invention the objective is solved by a contact arrangement having a longitudinal axis and comprising a first contact group with a first and a second contact and a second contact group with a third and a fourth contact. The first contact interacts electrically and mechanically with the third contact for closing and opening the contact arrangement. Additionally or alternatively the second contact interacts electrically and mechanically with the fourth contact for closing and opening the contact arrangement. At least one mechanical coupling is provided for transmitting an actuation force to the second contact group and thereby moving the second contact group. The at least one mechanical coupling is adapted to move the third and the fourth contact in such a way that their speeds differ along at least a portion of a travel path of the third contact or along at least a portion of a travel path of the fourth contact.

By designing the mechanical coupling in said way it is possible to decrease the forces acting on the contacts. This is due to the fact that the accelerations and/or decelerations of the third or the fourth contact, respectively, can be chosen to be different from one another, having values which take into account their respective travel path. For example, if the travel path of the fourth contact is longer than the travel path of the third contact, the acceleration of the third contact can be reduced. Consequently, mechanical stress on the moving parts of the contact arrangement or the switching device is reduced. Furthermore it is possible to fine-tune the time periods between the closing of the first and third contact and the closing of the second and fourth contact independently from one another, and/or between the opening of the first and third contact and the opening of the second and fourth contact independently from one another.

In a second aspect of the invention the objective is solved by an electrical switching device comprising such a contact arrangement. For closing and opening said electrical switching device the first contact group is movable along the longitudinal axis for providing the actuation force transmitted to the second contact group by the mechanical coupling of the contact arrangement according to a predefined transmission ratio and/or speed curve. Said actuation force can alternatively be provided by an actuator of the electrical switching device.

The first alternative is advantageously used in circuit breakers for which both contact groups are movable relatively to one another for closing and/or opening the electrical switching device. By using the first contact group for actuating the second contact group it is possible to save up additional actuators and thus to reduce the cost of the switching device.

The second alternative is advantageously used in circuit breakers for which only the second contact group is movable and the first contact group is fixed. In this case said actuator is used for moving the second contact group.

In embodiments, the first and the third contact are nominal contacts, and/or the second and the fourth contact are arcing contacts.

Advantageously, the at least one mechanical coupling is a linkage having a first and a second kinematic chain. The first kinematic chain is movably connected to the first contact group, particularly by an intermediary member, in an electrically insulating manner. The second kinematic chain is movably connected to the second contact group.

By using at least a linkage as a mechanical coupling, the transmission of an actuating force to the second contact group is simplified, thus reducing cost.

In one embodiment the mechanical coupling comprises a first and a second linkage. The end links of the first kinematic chain of each one of the linkages are pivotably connected to the first contact group in such a way that they are commonly moved by the first contact group, in particular are moved simultaneously. Advantageously, an end link of the second kinematic chain of each one of the linkages is pivotably connected to the third contact or the fourth contact, respectively. By this it is possible to keep the linkages simple. Advantageously, a transmission ratio between the first kinematic chain and the second kinematic chain of the first linkage is not equal to a transmission ratio between the first kinematic chain and the second kinematic chain of the second linkage.

By using two linkages with different transmission ratios a higher flexibility is achieved with regard to the travel path of the third and the fourth contact.

In another embodiment the mechanical coupling comprises only one linkage and the second kinematic chain of the linkage comprises two end links, one of which is connected at one end to the third contact and the other one is connected at one end to the fourth contact. This is a cost-saving and space-saving design. In one embodiment each end link of the second kinematic chain is pivotably connected to a neighbouring link of the second kinematic chain by a distinct joint. In an alternative embodiment the two end links of the second kinematic chain are connected to a neighbouring link of the second kinematic chain by a common joint. Advantageously, the common joint connects one of the end links of the second kinematic chain pivotably with the fourth contact and the other end link of the second kinematic chain is connected fixedly to the third contact, and in particular comprises a guide rail guiding the common joint. Advantageously, a transmission ratio between the first kinematic chain and the second kinematic chain with one of its end links is not equal to a transmission ratio between the first kinematic chain and the second kinematic chain with the other one of its end links.

### SHORT DESCRIPTION OF THE DRAWINGS

Embodiments, advantages and applications of the invention result from the dependent claims and from the now following description by means of the figures. It is shown in:

FIG. 1 a sectional side view of an embodiment of a high voltage circuit breaker with a mechanical coupling;

FIG. 2 a detail sectional side view of the contacts of the circuit breaker of FIG. 1 with a contact arrangement according to the prior art;

FIG. 3 a detail sectional side view of the contacts of the circuit breaker of FIG. 1 with a first embodiment of a contact arrangement according to the invention;

FIG. 4 a detail sectional side view of the contacts of the circuit breaker of FIG. 1 with a second embodiment of a contact arrangement according to the invention;

FIG. 5 a detail sectional side view of the contacts of the circuit breaker of FIG. 1 with a third embodiment of a contact arrangement according to the invention; and

FIG. 6 a diagram showing curves of a travel path over time of the contacts of the circuit breaker according to FIG. 1 with mechanical couplings according to the invention.

### WAYS OF CARRYING OUT THE INVENTION

The invention is described for the example of a high voltage circuit breaker, but the principles described in the following also apply for the usage of the invention in other switching devices, e.g. of the type mentioned at the beginning.

In the following same reference numerals denote structurally or functionally same or similar elements of the various embodiments of the invention.

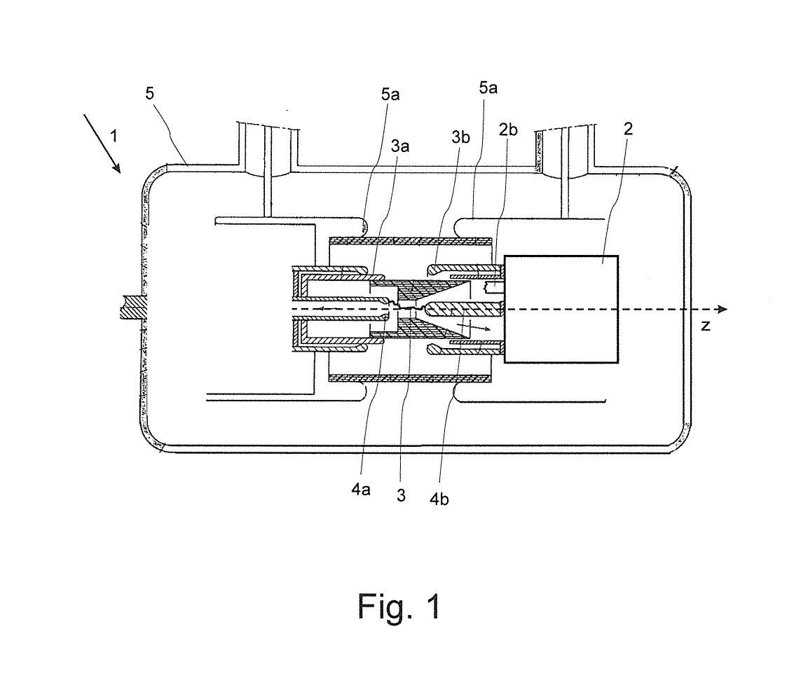

FIG. 1 shows exemplarily a sectional side view of an embodiment of a high voltage circuit breaker 1 during an opening process, with a mechanical coupling 2. The circuit breaker 1 without the mechanical coupling 2 is rotationally symmetric about a longitudinal axis z. Only the elements of the circuit breaker 1 which are related to the present invention will be described in the following, other elements present in the figures are not relevant for understanding the invention and are known by the skilled person in high voltage electrical engineering. The first contact is typically a first nominal contact 3a and the second contact is a first arcing contact 4a, both of them belonging to the first contact group. Accordingly, the third contact is a second nominal contact 3b and the fourth contact is a second arcing contact 4b.

The circuit breaker 1 is enclosed by a shell 5 which normally is cylindrical and arranged around the longitudinal axis z. The first nominal contact 3a comprises a plurality of contact fingers, of which only two are shown here for reasons of clarity. The nominal contact fingers are formed as a finger cage around the longitudinal axis z. The second mating nominal contact 3b normally is a tube or metal tube. A shielding 5a can be arranged around the first and the second nominal contact 3a, 3b, and the first and the second arcing contact 4a, 4b. Analogue to the first nominal contact 3a also the first arcing contact 4a comprises multiple fingers arranged in a finger cage. The second arcing contact 4b is normally rod-shaped.

The first contact group 3a, 4a is movable relatively to the second contact group 3b, 4b from a closed configuration, in which the respective contacts of the groups are in electrical contact to one another, into an opened configuration shown in FIG. 1, in which they are apart from one another, and vice versa. It is also possible that only the second contact group 3b, 4b moves parallel to the longitudinal axis z and the first contact group 3a, 4a is stationary. For the explanatory purposes of the present invention the first alternative is assumed. However, the invention is not limited to this configuration.

An “opened configuration” as used herein means that the nominal contacts 3a, 3b and/or the arcing contacts 4a, 4b of the circuit breaker 1 are opened. Accordingly, a “closed configuration” as used herein means that the nominal contacts 3a, 3b and/or the arcing contacts 4a, 4b of the circuit breaker 1 are closed. In particular, “opened configuration” and “closed configuration” relate to end positions of the nominal contacts 3a, 3b and/or arcing contacts 4a, 4b.

As mentioned the circuit breaker 1 is shown during an opening process of the electrical switching device 1 with an electric arc 3 between the arcing contacts 4a, 4b. This type of circuit breaker is known and will only be described in more detail here with respect to the actuation of the second contact group 3b, 4b and particularly with respect to the transmission of an actuation force to the second contact group 3b, 4b by the mechanical coupling 2.

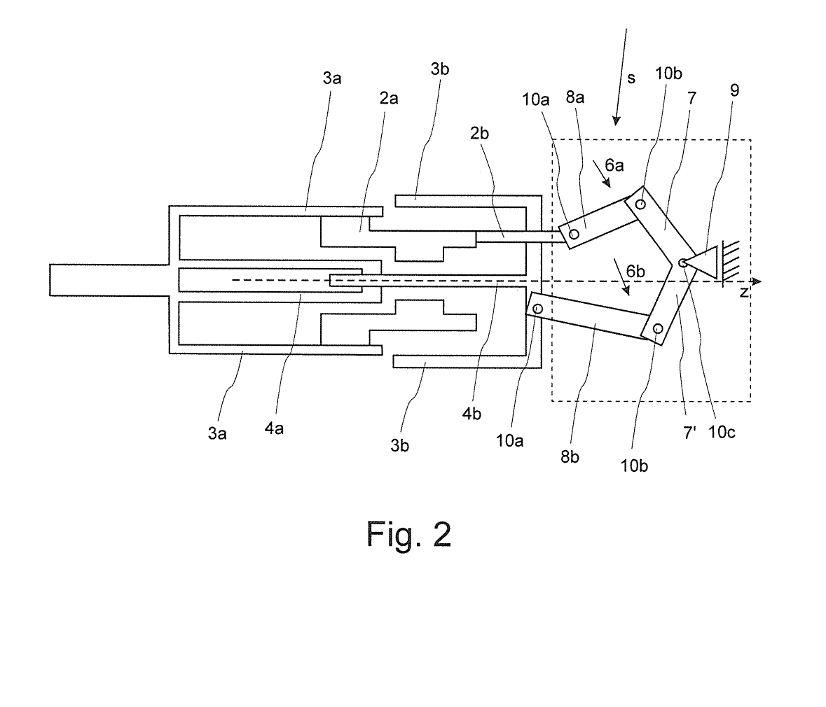

FIG. 2 shows a detail sectional side view of the contact arrangement of the circuit breaker 1, which is according to the prior art a full double motion interrupter.

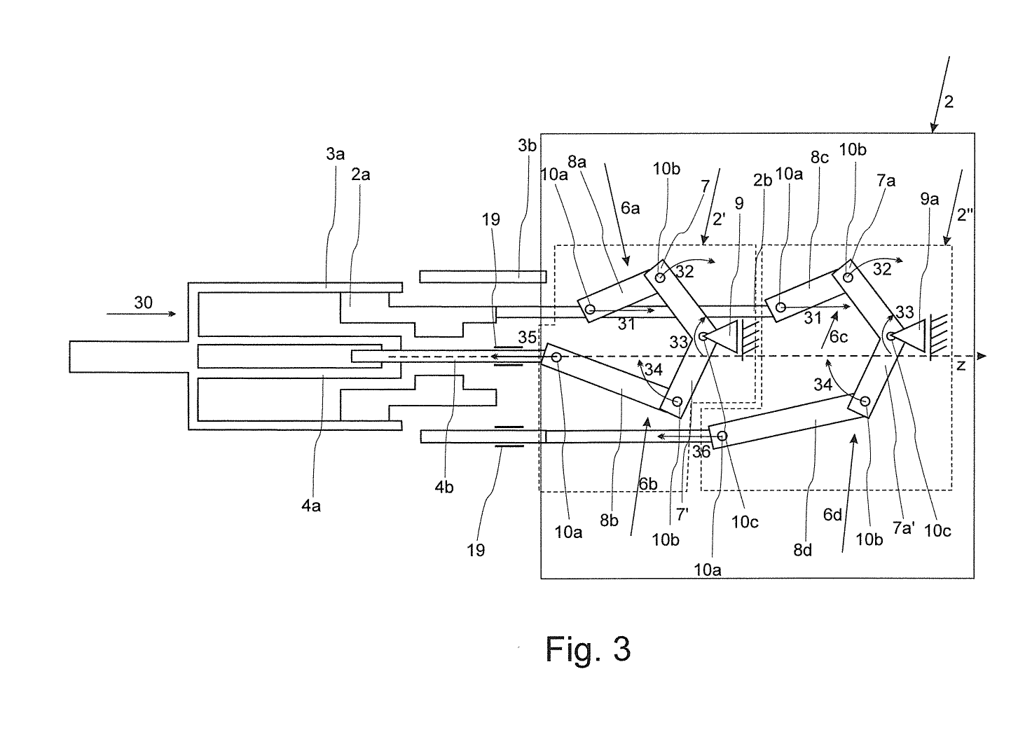

The circuit breaker 1 is shown during a closing process in this figure, in an instant when the second arcing contact 4b has already established contact to the mating arcing contact 4a. In the position of FIG. 2 (and FIG. 3-5) the nominal contacts 3a, 3b are shown in a still opened configuration. For opening the circuit breaker 1 the first contact group 3a, 4a is moved in the opposite direction of the arrow z and for closing the circuit breaker 1 it is moved in the direction of the arrow z. These assumptions are also valid for embodiments of the invention according to FIG. 3-5.

An insulating nozzle 2a is fixedly attached to the first contact group 3a, 4a. The main purpose of the insulating nozzle 2a is to control a flow of the fluid used to extinguish the electric arc 3 of FIG. 1. It is furthermore used to move an intermediary member 2b. The intermediary member may be a connecting rod 2b which is attached to a first kinematic chain 6a of a mechanical coupling s. The first kinematic chain 6a comprises a first link 7 and a second link 8a, which are connected by a joint 10b. The connecting rod 2b is attached to this second link 8a by a joint 10a. The mechanical coupling s further comprises a second kinematic chain 6b and is rotationally attached to a bearing 9 by means of a joint 10c. The second kinematic chain 6b comprises a first link 7′ and a second link 8b, which are connected by a joint 10b. The second link 8b is pivotably attached to the second contact group 3b, 4b by a joint 10a. In the following the joints depicted by a circle and having the same reference numeral shall be assumed to be of the same type throughout the disclosure. The joints 10a perform a linear movement parallel to the longitudinal axis z. The joints 10b connecting the first links 7, 7′ with the second links 8a, 8b of each kinematic chain 6a, 6b respectively, perform a rotational movement around the bearing 9. The joint 10c connecting the bearing 9 with the first links 7, 7′ is stationary and only allows a rotational movement of the first links 7, 7′. It is noted that the first and the second kinematic chain 6a, 6b may have more than two links, depending on the spatial arrangement of the mechanical coupling s with respect to the second contact group 3b, 4b. For the purposes of this disclosure only two links are assumed and the “second” link is equivalent to an “end” link regarding its naming. The first link 7, 7′ of one of the kinematic chains 6a, 6b is fixedly connected to the first link 7′, 7 of the other kinematic chain 6b, 6a. In other words the first links 7, 7′ may be made in one piece, with one leg belonging to the first kinematic chain 6a and the other leg belonging to the second kinematic chain 6b.

As mentioned above, a joint 10a couples the second contact group 3b, 4b to the mechanical coupling s. In the figure, the nominal contact 3b and the arcing contact 4b are shown to be connected by a bar containing the joint 10a. This is intended for illustration purposes to emphasize a rigid mechanical connection between the contacts 3b, 4b and that they are moved simultaneously via the joint 10a.

For the purposes of this entire disclosure the term “kinematic chain” is interpreted as an assembly of rigid bodies movably connected by joints or other elements. The rigid bodies, or links, are constrained by their connections to other links. The links for the mechanical coupling s may e.g. be metal bars.

In the following, the contact arrangement according to the prior art is replaced by embodiments of contact arrangements according to the invention, as triple motion interrupters. In this context “triple motion” refers to a motion of the first contact group 3a, 4a, a motion of the arcing contact 4b and a motion of the nominal contact 3b, whereas “double motion refers to a motion of the first contact group 3a, 4a and a motion of the second contact group 3b, 4b.

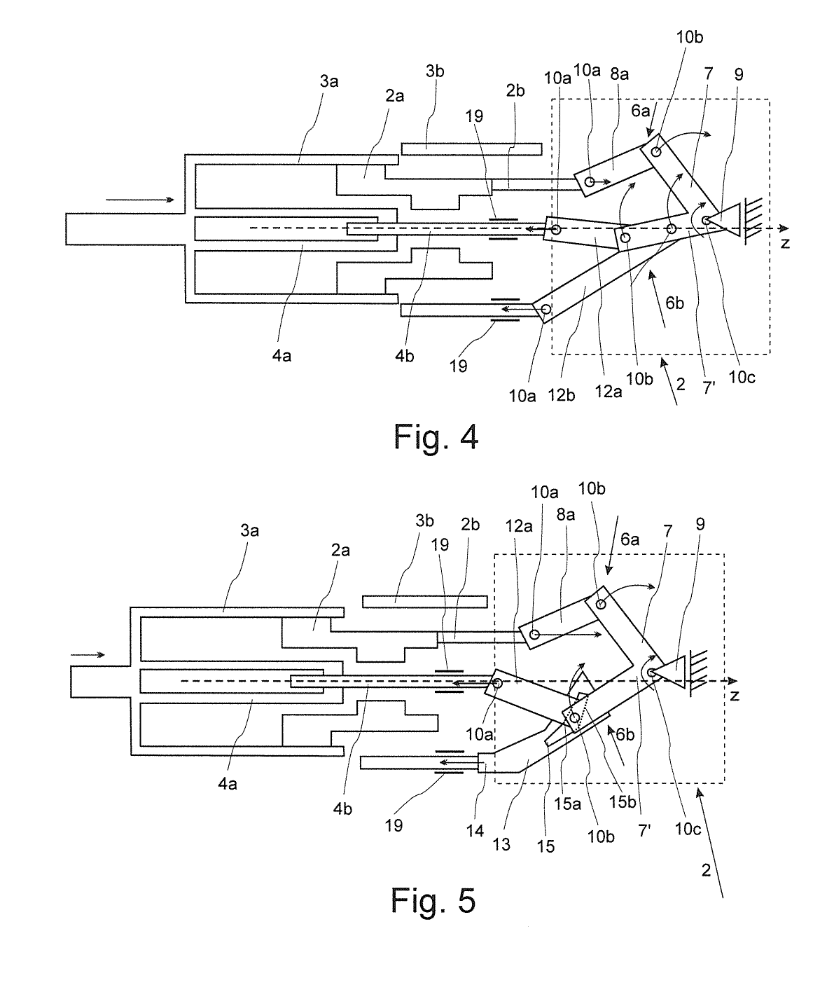

FIG. 3 shows a detail sectional side view of the contacts 3a, 3b, 4a, 4b of the circuit breaker 1 with a first embodiment of a contact arrangement according to the invention. In this embodiment a mechanical coupling 2 comprises a first and a second linkage 2′, 2″. The first linkage 2′ comprises a first and a second kinematic chain 6a and 6b, each of which is formed by a first link 7, 7′ and an end link 8a, 8b, respectively. The second linkage 2″ comprises a first and a second kinematic chain 6c and 6d, each of which is formed by a first link 7a, 7a′ and an end link 8c, 8d, respectively. The first linkage 2′ is attached to a bearing 9 and the second linkage 2″ is attached to a bearing 9a. The end links 8a, 8c of the first kinematic chains 6a, 6c are both connected to an intermediary member 2b. Preferably, the intermediary member 2b is a connecting rod or tube or bar which is linearly movable parallel to the longitudinal axis z by a mechanical force exerted on it, for example by a moving insulating nozzle 2a connected to the first contact group 3a, 4a or otherwise by an intermediary member of any kind. The insulating nozzle 2a has been explained in connection with FIG. 2. Such an arrangement of the connecting rod 2b and the insulating nozzle 2a is also preferred for the subsequent embodiments of the invention according to FIGS. 4 and 5. By this connection type it is made sure that the second contact group 3b, 4b is not moved before the first contact group 3a, 4a is moved. This alternative can e.g. be used for circuit breakers 1 featuring two movable contact groups.

The end links 8a, 8c may also be connected to another type of actuating device (not shown) arranged within the circuit breaker 1. By this it is made sure that the second contact group 3b, 4b can be moved independently of the first contact group 3a, 4a. This alternative can e.g. be used for circuit breakers 1 featuring a fixed contact group (here the first contact group) and a movable contact group (here the second contact group).

It shall be noted that the usage of an alternative actuator for the first linkage 2′ and the second linkage 2″ is possible for all embodiments of the mechanical coupling 2 (e.g. of FIGS. 4 and 5) if the type of circuit breaker used requires this arrangement.

In the following the movement of the individual moving parts of the circuit breaker 1 are explained for the case when the circuit breaker 1 is being closed, based on the double arrows 30 to 36. The opening of the circuit breaker 1 is analogous, with the double arrows pointing into the opposite direction. It shall be noted that the double arrows 31 to 34 of the first linkage 2′ and of the second linkage 2″ indicate in FIG. 3 a same movement of the respective element with respect to direction and distance and/or speed, whereas the double arrows 35 and 36 indicate a same movement of the respective element only with respect to direction, but not with respect to distance and/or speed. Double arrows starting inside a joint represent the movement of the joint. Double arrows arranged around a joint represent a movement of links.

In a first step the first contact group 3a, 4a is shifted along the longitudinal axis z in the direction of the arrow 30. By this, the nozzle 2a, which is fixedly attached to the first contact group 3a, 4a, and the connecting rod 2b also move in this direction. Consequently, the joints 10a of the end links 8a, 8c of the first kinematic chains 6a, 6c of the respective linkages 2′, 2″ also perform a linear movement in the direction of the arrows 31. Thereby, the joints 10b connecting the end links 8a and 8c with the respective first links 7, 7a are pushed in the direction of the arrows 32. The respective first links 7, 7a thereby rotate about their corresponding bearing 9, 9a (arrows 33), causing the joints 10b between the first links 7′, 7a′ and the end links 8b, 8d of the corresponding second kinematic chains 6b, 6d to perform a rotation in the direction of the arrows 34. By this, the end links 8b, 8d of the respective second kinematic chain 6b, 6d are pushed in a linear direction of the arrows 35 and 36 respectively. Each end link 8b, 8d pushes, via the respective joints 10a, the respective contact of the second contact group 3b, 4b towards the first contact group 3a, 4a. The length or shape in general of the end links 8b, 8d determine the shifting distance of the respective contact 3b, 4b and/or their shifting speed.

As can be seen in FIG. 3 by the “thicker” lines 19, the third contact 3b and/or the fourth contact 4b is or are provided each with a guiding element 19 for guiding the third contact 3b and/or the fourth contact 4b, respectively, along a linear path during the closing and the opening of the contact arrangement. The provision of the guiding element or elements 19 is preferred, because it supports the respective contact against radial force components acting on it when the mechanical coupling 2 is actuated for opening or closing the contact arrangement. The following embodiments of the invention are also preferably provided with such guiding elements 19.

FIG. 4 shows a detailed sectional side view of the contacts 3a, 3b, 4a, 4b of the circuit breaker 1 in a second embodiment of a contact arrangement according to the invention. In this embodiment the mechanical coupling is formed by a single linkage 2. The first kinematic chain 6a of the linkage 2 is the same as the first kinematic chains of the linkages 2′, 2″ of the embodiment of FIG. 3 and is also connected by a joint 10a to a connecting rod 2b. Therefore it will not be described in more detail. The second kinematic chain 6b of the linkage 2 has a first end link 12a which is pivotably connected to the fourth contact 4b and a second end link 12b which is pivotably connected to the third contact 3b. The end links 12a, 12b are connected at their other end to the first link 7′ of the second kinematic chain 6b by means of two distinct joints 10b. In this embodiment the transmission ratios between the first kinematic chain 6a and the two branches of the second kinematic chain 6b is different. The difference between the two ratios is given by the relative design and arrangement of the two branches, and in particular on the one hand by the distance between the joints 10b linking the first link 7′ of the second kinematic chain 6b with each one of the end links 12a, 12b and on the other hand by the length difference of the two end links 12a, 12b.

The movement of the moving parts is in this embodiment analogous to the movement of one of the linkages 2′, 2″ of FIG. 3 and will therefore not be explained here in more detail. The double arrows again represent the movement directions during the closing process.

FIG. 5 shows a detail sectional side view of the contacts 3a, 3b, 4a, 4b of the circuit breaker 1 with a third embodiment of a contact arrangement according to the invention. In the following only the differences to the embodiment of FIG. 4 are described. In this embodiment the two end links 12a, 13 are linked to the first link 7′ of the second kinematic chain 6b by means of a common joint 10b. The first end link 12a has an identical connection like the one in FIG. 4. The second end link 13 comprises a guide rail 15 which guides the common joint 10b. The second end link 13 is fixedly attached to the third contact 3b by means of a joint 14. Thus it is attached to said contact 3b in a stiff way and can therefore only perform a translation movement parallel to the longitudinal axis z. Contrary to this the common joint 10b can only perform a rotational movement around the bearing 9, being constrained by the rigid first link 7′. The result is that the third contact 3b is shifted back and forth by the constraint of the movement of the common joint 10b in the guide rail 15. When the electrical switching device 1 is being closed, the common joint 10b rotates in the direction shown by the double arrow, thus impacting a first side 15a of the guide rail 15 and gliding along it, thus forcing the corresponding end link 13 to shift in the direction of the arrow of the joint 14. When the switching device 1 is being opened the common joint 10b rotates in the opposite direction, impacts a second side 15b of the guide rail and glides along it, thus forcing the corresponding end link 13 to move in the direction of the arrow z. The difference between the transmission ratio of the first kinematic chain 6a with the one branch of the second kinematic chain 6b and the transmission ratio of the first kinematic chain 6a with the other branch of the second kinematic chain 6b is given by the shape of the guide rail 15. More precise, the steepness of the sides 15a and 15b with respect to the horizontal direction in the figure is decisive for the distance and acceleration of the end link 13 in either shift direction.

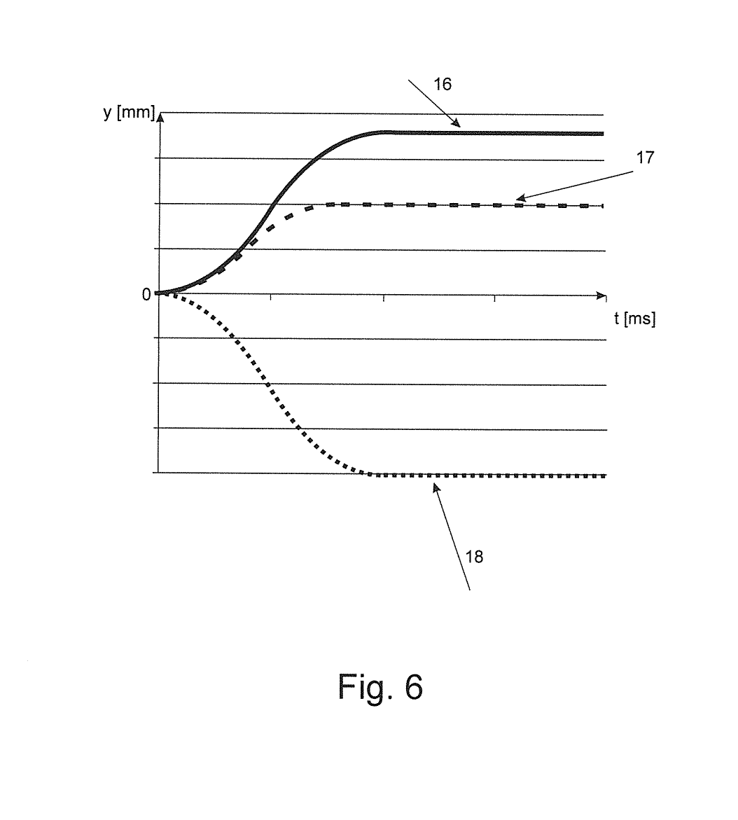

FIG. 6 shows a diagram showing curves of a travel path over time of the contacts 3a, 3b, 4a, 4b of the circuit breaker 1 with contact arrangements according to embodiments of the invention, e.g. during the opening process of the electrical switching device 1. As mentioned, exemplarily the first contact represents the nominal contact 3a of the first contact group, the second contact represents the arcing contact 4a of the first contact group, the third contact represents the nominal contact 3b of the second contact group and the fourth contact represents the arcing contact 4b of the second contact group. The axis of ordinates represents the shifting or travel distance of the contacts of the switching device 1 in millimeters and the axis of abscissae represents the time in milliseconds. The solid curve 16 shows a travel curve of the arcing contact 4b. The dashed curve 17 shows a travel curve of the nominal contact 3b and the dotted curve 18 shows the travel curve of the nominal and the arcing contact 3a, 4a. The value of zero meters represents the position in which the electrical switching device 1 is in a completely closed state and the contacts are idle or in their starting position. The positive and negative displacement values (Y-axis) of the shift values represent movements in opposite directions.

As can be seen, the arcing contact 4b travels a longer distance than the nominal contact 3b. The nominal contact 3a and the arcing contact 4a travel with the same speed and acceleration and cover the same distance as they are fixedly attached together. Generally it can be seen that the contacts are accelerated at the beginning of their travel path and are decelerated towards the end of their travel path. During the closing process the mechanical coupling 2 pulls back the nominal contact 3b and the arcing contact 4b in such a way that the nominal contact 3b disconnects first from the mating nominal contact 3a and thereafter the arcing contact 4b is decoupled from the mating arcing contact 4a.

During the closing process the contacts travel the curves of FIG. 6 in the opposite direction due to the nature of the mechanical coupling 2. The arcing contact 4b contacts the arcing contact 4a before the nominal contacts 3a, 3b contact one another. As can be derived from FIG. 6, the nominal contact 3b is positioned relatively close to the point where it will first touch the mating nominal contact 3a but, as it is travelling slower than the arcing contact 4b, it will reach the contact point later than the arcing contact 4b reaches its contact point with the mating arcing contact 4a. Therefore, the nominal contact 3b can be placed altogether closer to its mating contact. The advantage is that the mechanical forces acting during the movement are reduced and the required drive energy is smaller.

Advantageously, the mechanical coupling is adapted such that a predefined time period between the touching or separation of the nominal contact 3a and the nominal contact 3b and the touching or separation of the arcing contact 4a and the arcing contact 4b is not exceeded.

As mentioned, the mechanical coupling is advantageously adapted such that the arcing contact 4b is moved faster than the nominal contact 3b. Preferably, a speed of the nominal contact 3b and/or the arcing contact 4b is non-linear. In particular, the mechanical coupling 2 is adapted such that a speed of the third contact 3b is a first non-linear function of time and a speed of the fourth contact 4b is a second non-linear function of time, and the first and second non-linear functions are different. Additionally or alternatively the travel path of the arcing contact 4b may be longer than the travel path of the nominal contact 3b.

The described contact arrangement is preferably used in an electrical switching device like an earthing device, a fast-acting earthing device, a circuit breaker, a generator circuit breaker, a switch disconnector, a combined disconnector and earthing switch, or a load break switch. Where applicable, the first contact group 3a, 4a of the electrical switching device 1 is movable along the longitudinal axis z for closing and opening said electrical switching device 1 in order to provide the actuation force transmitted to the second contact group 3b, 4b by the mechanical coupling 2 of the contact arrangement according to a predefined transmission ratio and/or speed curve. In other switching devices, in which the first contact group is fixed, the electrical switching device may comprise the additional actuator mentioned above in order to provide the actuation force transmitted to the second contact group 3b, 4b by the mechanical coupling 2 of the contact arrangement, also according to a predefined transmission ratio and/or speed curve.

By providing a mechanical coupling according to the invention it is possible to make the switching device more compact even though the contacts of the switching device still have the same size. Furthermore, mechanical stress on the moving parts is reduced.

While there are shown and described presently preferred embodiments of the invention, it is to be distinctly understood that the invention is not limited thereto but may otherwise variously be embodied and practised within the scope of the following claims. Therefore, terms like “preferred” or “in particular” or “particularly” or “advantageously”, etc. signify optional and exemplary embodiments only.

### LIST OF REFERENCE NUMERALS

1=circuit breaker
2=mechanical coupling
2′=first linkage
2″=second linkage
2a=insulating nozzle
2b=connecting rod
3=electric arc
3a=first nominal contact
3b=second nominal contact
4a=first arcing contact
4b=second arcing contact
5=shell
5a=shielding
6a=first kinematic chain of first linkage
6b=second kinematic chain of first linkage
6c=first kinematic chain of second linkage
6d=second kinematic chain of second linkage
7, 7′, 7a, 7a′=first link of kinematic chains
8a=end link of first kinematic chain of first linkage
8b=end link of second kinematic chain of first linkage
8c=end link of first kinematic chain of second linkage
8d=end link of second kinematic chain of second linkage
9=bearing of first linkage
9a=bearing of second linkage
10a=joints between links and contacts
10b=joints between two links
12a=first end link
12b=second end link
13=guide rail end link
14=fixed joint
15=guide rail of end link
15a=first side of guide rail
15b=second side of guide rail
16=travel curve of fourth contact
17=travel curve of third contact
18=travel curve of first and second contact
30-36=double arrows representing moving directions
s=mechanical coupling according to the prior art
z=longitudinal axis

1. Contact arrangement having a longitudinal axis (z), and comprising:
a first contact group with a first contact and a second contact; and
a second contact group with a third contact and a fourth contact;
wherein the first contact interacts electrically and mechanically with the third contact, and/or the second contact interacts electrically and mechanically with the fourth contact, for closing and opening the contact arrangement;
wherein at least one mechanical coupling is provided for transmitting an actuation force to the second contact group for moving the second contact group; and
wherein the at least one mechanical coupling is adapted to move the third contact and the fourth contact in such a way that their speeds will differ along at least a portion of a travel path of the third contact or along at least a portion of a travel path of the fourth contact.

2. Contact arrangement according to claim 1, wherein the first contact and the third contact are nominal contacts, and/or the second contact and the fourth contact are arcing contacts.

3. Contact arrangement device according to claim 1, wherein the at least one mechanical coupling is a linkage comprising:
a first kinematic chain and a second kinematic chain, wherein the first kinematic chain is movably connected to the first contact group in an electrically insulating manner and the second kinematic chain is movably connected to the second contact group.

4. Contact arrangement according to claim 3, wherein the first kinematic chain and the second kinematic chain have each comprise:
at least two links, wherein a first link of early kinematic chain is rotationally connected to a bearing and fixedly connected to a first link of the other kinematic chain, an end link of the first kinematic chain is being movably connected to the first contact group; and at least an end link of the second kinematic chain being movably connected to the second contact group.

5. Contact arrangement according to claim 4, wherein the mechanical coupling comprises:
a first linkage and a second linkage, and the end links of the first kinematic chain of each one of the linkages are pivotably connected to the first contact group in such a way that they are moved by the first contact group simultaneously.

6. Contact arrangement according to claim 4, wherein an end link of the second kinematic chain of the first linkage is pivotably connected to the fourth contact, and/or an end link of the second kinematic chain of the second linkage is pivotably connected to the third contact.

7. Contact arrangement according to claim 5, wherein a transmission radio between the first kinematic chain and the second kinematic chain of the first linkage is not equal to a transmission ratio between the first kinematic chain and the second kinematic chain of the second linkage.

8. Contact arrangement according to claim 3, wherein the mechanical coupling comprises:
one linkage, and the second kinematic chain of the linkage comprises:
two end links, each of which is connected at one end to the third contact or the fourth contact, respectively.

9. Contact arrangement according to claim 8, wherein each end link of the second kinematic chain is pivotably connected to a neighbouring link of the second kinematic chain by a distinct joint.

10. Contact arrangement according to claim 8, wherein the two end links of the second kinematic chain are connected to a neighbouring link of the second kinematic chain by a common joint.

11. Contact arrangement according to claim 10, wherein the common joint connects one of the end links of the second kinematic chain pivotably with the fourth contact, and the other end link of the second kinematic chain is connected fixedly to the third contact.

12. Contact arrangement according to claim 8, wherein a transmission ratio between the first kinematic chain and the second kinematic chain with one of its end links is not equal to a transmission ratio between the first kinematic chain and the second kinematic chain with the other one of its end links.

13. Contact arrangement according to claim 3, wherein the first kinematic chain is connected to the first contact group via an intermediary member which is a connecting rod or tube, which is linearly movable parallel to the longitudinal axis (z) when a mechanical force is exerted on it by a movable insulating nozzle of the first contact group.

14. Contact arrangement according to claim 1, wherein the mechanical coupling is adapted such that a predefined time period between the touching or separation of the first and the third contact and touching or separation of the second and the fourth contact is not exceeded.

15. Contact arrangement according to claim 1, wherein the mechanical coupling is adapted such that the fourth contact will be moved faster than the third contact, and/or that a travel path of the fourth contact will be longer than a travel path of the third contact during operation.

16. Contact arrangement according to claim 1, wherein the mechanical coupling is adapted such that a speed of the third and/or the fourth contact will be non-linear as a function of time.

17. Contact arrangement according to claim 1, wherein the third contact is provided with a guiding element for guiding the third contact along a linear path during the closing and the opening of the contact arrangement, and/or the fourth contact is provided with a guiding element for guiding the the fourth contact along a linear path during the closing and opening of the contact arrangement.

18. Electrical switching device comprising:
a contact arrangement according to claim 1, wherein for closing and opening said electrical switching device either the first contact group is configured to be movable along the longitudinal axis (z), or the electrical switching device includes an actuator, for providing actuation force to the second contact group by the mechanical coupling of the contact arrangement according to a predefined transmission ratio and/or speed curve.

19. Electrical switching device according to claim 18, configured with one of the group consisting of: an earthing device, a fast-acting earthing device, a circuit breaker, a generator circuit breaker, a switch disconnector, a combined disconnector and earthing switch, or a load break switch.
